(19) United States
(12) Patent Application Publication
(10) Pub. No.: US 2016/0372002 A1
(43) Pub. Date: Dec. 22, 2016

(54) ADVICE GENERATION METHOD, ADVICE GENERATION PROGRAM, ADVICE GENERATION SYSTEM AND ADVICE GENERATION DEVICE

(71) Applicant: Seiko Epson Corporation, Tokyo (JP)

(72) Inventors: Michihiro Nagaishi, Suwa-shi (JP); Hideto Yamashita, Suwa-shi (JP)

(21) Appl. No.: 15/174,961

(22) Filed: Jun. 6, 2016

(30) Foreign Application Priority Data
Jun. 17, 2015 (JP) 2015-121784

(51) Int. Cl. G09B 19/00

(52) U.S. Cl. CPC G09B 19/003

(57) ABSTRACT

An advice generation method includes: acquiring personal information about a user; searching for an similar person who is similar to the user on the basis of the personal information; acquiring history information about physical training carried out by the similar person; and generating advice information on the physical training for the user on the basis of the history information.

### CROSS-REFERENCES TO RELATED APPLICATIONS

This application claims priority to Japanese Patent Application No. 2015-121784, filed Jun. 17, 2015, the entirety of which is herein incorporated by reference.

### BACKGROUND

1. Technical Field

The present invention relates to an advice generation method, an advice generation program, an advice generation system and an advice generation device.

2. Related Art

It is said that receiving instructions from a good coach or trainer is a short cut to improve skills in sports. In golf, for instance, there are services in which a player receives lessons directly from an instructor called a teaching pro or in which a player sends a video of his/her swings and receives advice on it.

However, ordinary sports enthusiasts find it hard to spend a lot of time and money on receiving instructions, and often use commercially available practice machines to practice and improve their skills on their own. Many of such practice machines simply capture and display movements of the user who practices, the ball and the like, but such motion analysis alone is not enough for improvement in skills in sports. Thus, a sports practice machine which offers advice on points to be improved as a result of analysis is proposed.

For example, JP-A-2013-27629 proposes an exercise instruction device which offers advice for instructions according to the physique, movement habits and the like of the user.

However, even when the advice for instructions is generated according to characteristics of the user, if the content of the training menu indicated by the advice is rigorous for the user, many users find it difficult to continuously execute the proposed menu. Consequently, the user cannot sufficiently benefit from effects that can be achieved by continuous training.

### SUMMARY

An advantage of some aspects of the invention is to propose training that is easily acceptable to the user.

The invention can be implemented in the following configurations or application examples.

### Application Example 1

An advice generation method according to this application example includes: acquiring personal information about a user; searching for an similar person who is similar to the user on the basis of the personal information; acquiring history information about physical training carried out by the similar person; and generating advice information on the physical training for the user on the basis of the history information.

According to this method, personal information about the user is acquired and an similar person who is similar to the user is searched for on the basis of the personal information. Then, history information about physical training carried out by the similar person is acquired and advice information about the physical training for the user is generated on the basis of the history information. Thus, since the advice information of physical training for the user is generated on the basis of the history information of the physical training carried out by the similar person whose personal information is similar to that of the user, physical training that is suitable for and acceptable to the user can be proposed.

### Application Example 2

In the advice generation method according to the application example, it is preferable that, in the acquisition of the personal information, the personal information including biological information about a biological body and motion information about a movement is acquired.

According to the method with this configuration, in the acquisition of the personal information, the biological information of the user and the motion information are acquired as the personal information. Therefore, information about the biological body of the user and information about the movement can be acquired as personal information.

### Application Example 3

In the advice generation method according to the application example, it is preferable that, in the search, by focusing on profile information including physical fitness information about physical fitness of the user and the personal information, the similar person who has the profile information that is the most similar to that of the user is searched for from information saved in a database.

According to the method with this configuration, the similar person who has the physical fitness information and personal information that are the most similar to those of the user can be extracted from the information in the database.

### Application Example 4

In the advice generation method according to the application example, it is preferable that, in the acquisition of the history information, the history information including a training item carried out in the physical training and a training duration of the training items is acquired.

According to the method with this configuration, by acquiring the history information, it is possible to acquire the information of the training item carried out in the physical training by the similar person and the training duration of each training item.

### Application Example 5

In the advice generation method according to the application example, it is preferable that, in the generation, a first training duration for the training item is decided on the basis of the motion information and then a third training duration recommended in the advice information is decided on the basis of the first training duration that is decided and a second training duration indicated by the history information.

According to the method with this configuration, the third training duration is decided on the basis of the first training duration decided on the basis of the motion information of the user and the second training duration indicated by the history information of the similar person. Therefore, a training duration that is not unreasonable and is more acceptable to the user can be proposed.

### Application Example 6

In the advice generation method according to the application example, in the generation, the history information of the similar person may be generated as the advice information.

### Application Example 7

In the advice generation method according to the application example, the biological information may include at least one of pulse rate, body temperature and blood pressure in the biological body.

### Application Example 8

In the advice generation method according to the application example, the motion information may include at least one of acceleration and angular velocity generated by a movement of the user.

### Application Example 9

It is preferable that the advice generation method according to the application example includes outputting the advice information that is generated.

According to the method with this configuration, the advice information that is generated can be outputted and thus disclosed.

### Application Example 10

An advice generation program according to this application example causes a computer to execute: a personal information acquisition function of acquiring personal information about a user; a search function of searching for an similar person who is similar to the user on the basis of the personal information; a history information acquisition function of acquiring history information about physical training carried out by the similar person; and a generation function of generating advice information on the physical training for the user on the basis of the history information.

According to this configuration, personal information about the user is acquired and an similar person who is similar to the user is searched for on the basis of the personal information. Then, history information about physical training carried out by the similar person is acquired and advice information about the physical training for the user is generated on the basis of the history information. Thus, since the advice information of physical training for the user is generated on the basis of the history information of the physical training carried out by the similar person whose personal information is similar to that of the user, physical training that is suitable for and acceptable to the user can be proposed.

### Application Example 11

An advice generation system according to this application example includes: a personal information acquirer which acquires personal information about a user; a searcher which searches for an similar person who is similar to the user on the basis of the personal information; a history information acquirer which acquires history information about physical training carried out by the similar person; and a generator which generates advice information on the physical training for the user on the basis of the history information.

According to this configuration, personal information about the user is acquired and an similar person who is similar to the user is searched for on the basis of the personal information. Then, history information about physical training carried out by the similar person is acquired and advice information about the physical training for the user is generated on the basis of the history information. Thus, since the advice information of physical training for the user is generated on the basis of the history information of the physical training carried out by the similar person whose personal information is similar to that of the user, physical training that is suitable for and acceptable to the user can be proposed.

### BRIEF DESCRIPTION OF THE DRAWINGS

The invention will be described with reference to the accompanying drawings, wherein like numbers reference like elements.

FIG. 1 shows the configuration of an exercise instruction system according to an embodiment of the invention.

FIG. 2 shows the arrangement of components of the exercise instruction system.

FIG. 3 shows a sensor module attached to a band.

FIG. 4 shows the configuration of basic data.

FIG. 5 explains an arm motion model.

FIG. 6 shows an example of wearing a sensor module.

FIG. 7 explains processing of deciding recommended training.

FIG. 8 is a flowchart showing a flow of processing in the exercise instruction system.

FIG. 9 shows a modification of the processing of deciding recommended training.

### DESCRIPTION OF EXEMPLARY EMBODIMENTS

Hereinafter, an embodiment of the invention will be described with reference to the drawings.

### Embodiment

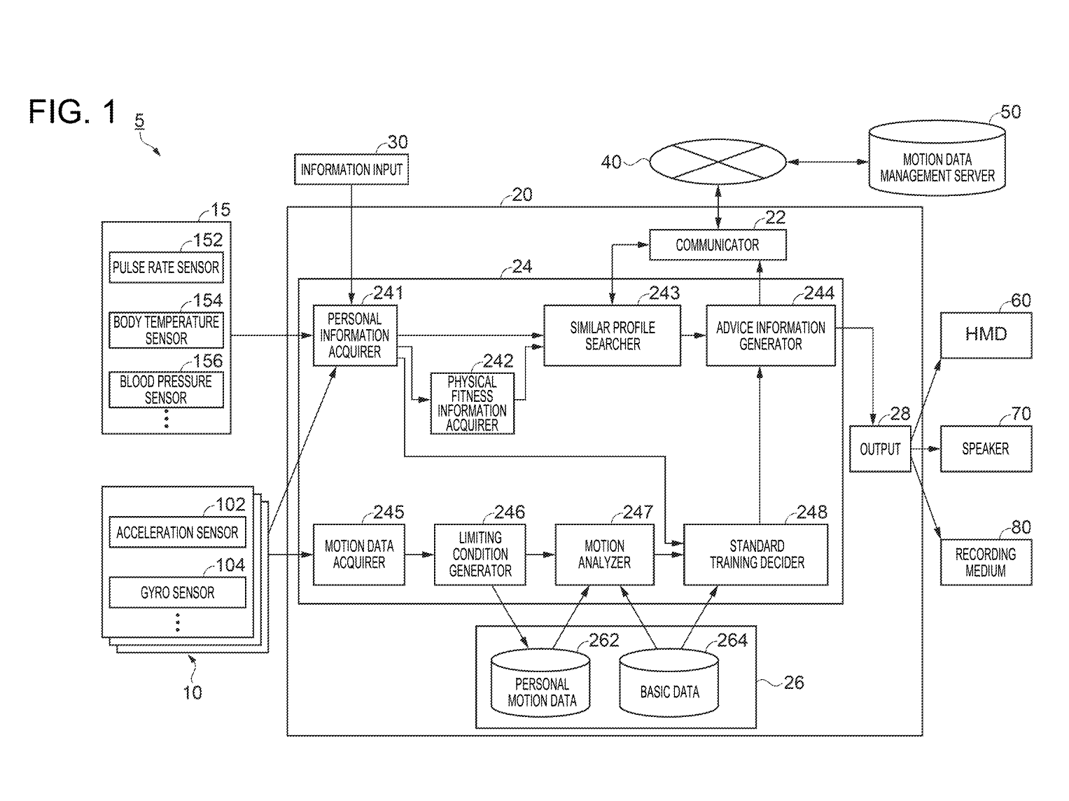

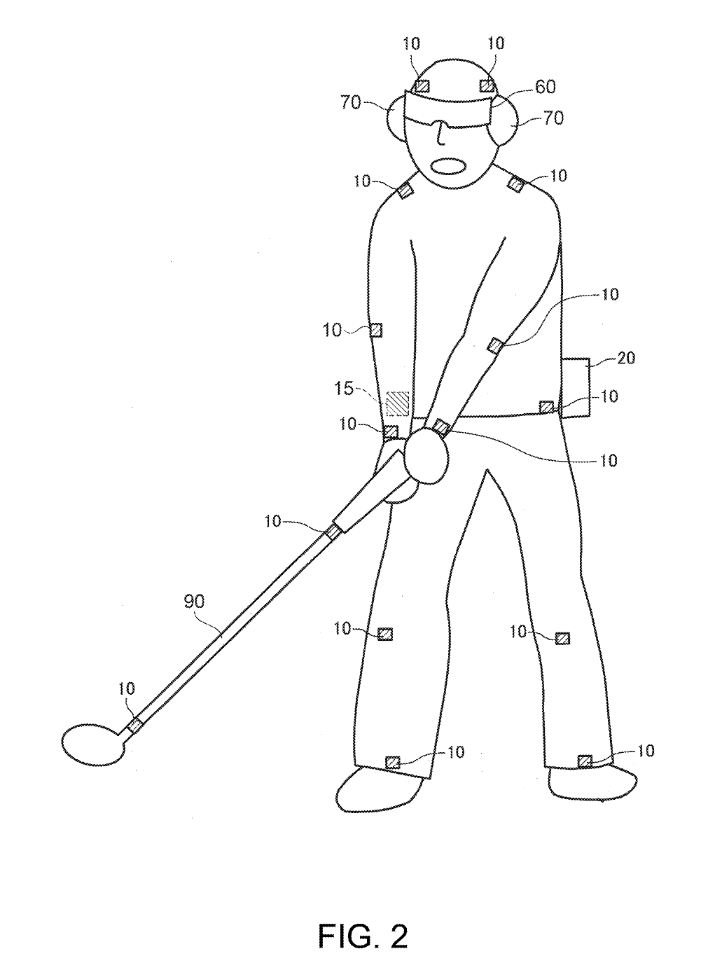

FIG. 1 shows an example of the configuration of an exercise instruction system 5, which is an example of embodiment of the advice generation system. FIG. 2 shows an example of arrangement of components of the exercise instruction system 5. In this embodiment, a case where an instruction (advice) on golf training is given to the user as physical training will be described as an example. However, the invention can also be applied to the generation of advice on various other sports such as tennis and baseball and advice on physical exercises other than sports, such as rehabilitation exercise.

The exercise instruction system 5 according to the embodiment includes a plurality of sensor modules 10, 15, a controller 20, a head-mounted display (HMD) 60, a speaker 70, and a recording medium 80. In the exercise instruction system 5 of the embodiment, a part of these components (elements) can be omitted and a new component (element) can be added as well.

The sensor modules 10, 15 are modules for detecting physical information including motion information about movements and biological information of the user.

The plurality of sensor modules 10 has motion detection sensors, that is, a three-axis acceleration sensor 102 and a three-axis gyro sensor 104, and also has at least one sensor to acquire data necessary for calculation of the value of each parameter of a motion model in order to analyze a movement of the user, such as a infrared sensor, magnetic direction sensor (three-axis) or pressure sensor, not shown.

The acceleration sensor 102, the gyro sensor 104 and the pressure sensor can output information such as velocity, location and degree of impact. The two infrared sensors can output information of a distance between two points. The magnetic direction sensor can output information of location.

The sensor module 15 has biological information detection sensors, that is, a pulse rate sensor 152, a body temperature sensor 154, a blood pressure sensor 156 and the like, and acquires data about the biological body of the user.

As shown in FIG. 2, the sensor modules 10 are mounted mainly on joints of the user, for example, on the head, shoulders, lumbar, elbows, wrists, knees, ankles, malleoli and the like. For example, the sensor modules 10 may be attached onto the user's clothes, as shown in FIG. 2. Meanwhile, the sensor module 15 is mounted in contact with the user's wrist or the like.

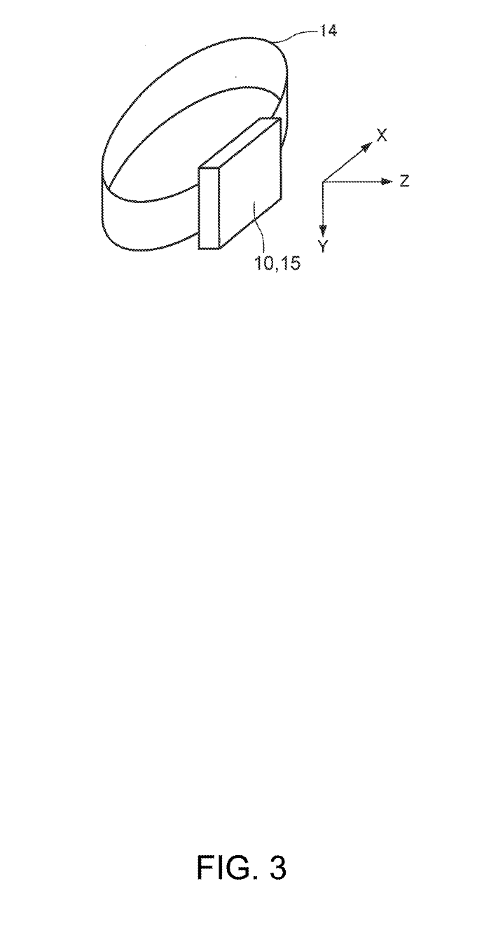

The sensor modules 10, 15 may also be attached to a band 14, as shown in FIG. 3, and the band 14 may be installed at each site on the user. Also, some of the sensor modules 10 may be mounted on sports equipment such as a golf club 90.

Since the sensor modules 10 are not necessarily to acquire the same information depending on the mounting sites, each sensor module may include a minimum necessary sensor capable of acquiring information to be acquired.

The controller 20 wirelessly transmits control data to start or stop the sensor modules 10, 15, to the sensor modules 10, 15. Data from the respective sensor modules 10, 15 that are started up are wirelessly transmitted to the controller 20. The controller 20 may be mounted on the player's lumbar, for example, as shown in FIG. 2, or may be situated away from the player.

The controller 20 in the embodiment includes a communicator 22, a processor (CPU) 24, an output 28, and a memory 26. The controller 20 acquires data outputted from the sensor modules 10, 15, and generates and displays information for exercise instructions using the acquired data.

In the embodiment, the processor (CPU) 24 has a personal information acquirer 241, a physical fitness information acquirer 242, a similar profile searcher 243, an advice information generator 244, a motion data acquirer 245, a limiting condition generator 246, a motion analyzer 247, and a standard training decider 248.

In the processor 24, a part of the configuration (components) maybe omitted or a new configuration (component) may be added.

The recording medium 80 is a computer-readable recording medium. An exercise instruction program for causing a computer to function as each of the above components is stored in the recording medium 80. Each functional component of the processor 24 in the embodiment implements each function by executing the exercise instruction program stored in the recording medium 80.

Also, the communicator 22 may receive an exercise instruction program from a server device via a network 40, and the received exercise instruction program may be stored in the memory 26 and the recording medium 80 so as to execute the exercise instruction program. Moreover, at least a part of the functional components may be implemented by hardware (dedicated circuit).

The recording medium 80 can be implemented by an optical disk (CD, DVD), magneto-optical disk (MO), magnetic disk, hard disk, magnetic tape, or memory (ROM, flash memory or the like), for example.

In the embodiment, the focus is put on the following functions, of the various functions of the processor (CPU) 24.

(1) The function of deciding a standard training menu on the basis of motion data of the user.

(2) The function of acquiring a profile of a similar person on the basis of biological information of the user.

(3) The function of deciding a training menu recommended to the user on the basis of the profile of the similar person.

Each of the functions to focus on will be described.

### (1) Decision on Standard Training Menu

The function relating to the decision on a standard training menu is implemented by the motion data acquirer 245, the personal information acquirer 241, the limiting condition generator 246, the motion analyzer 247 and the standard training decider 248.

The motion data acquirer 245 continuously acquires data from each sensor included in each sensor module 10 at a predetermined time interval.

The personal information acquirer 241 continuously acquires data indicating personal information from each sensor included in the sensor modules 10, 15 at a predetermined time interval. The personal information acquirer 241 also acquires physique information of the user such as height, weight and chest measurement, and attribute information such as name, gender and age, as personal information from an information input 30. The personal information acquired by the personal information acquirer 241 may also include information about BMI value, full-size photograph of the body, personality and movement habits of the user.

The information input 30 is assumed to be a keyboard, touch panel or the like, and is assumed to be configured in such a way that the user himself/herself inputs information in advance. The information input 30 may also be configured in such a way that information is inputted by communication via the network 40.

The limiting condition generator 246 carries out processing of generating parameter limiting conditions for a human body model, described later, according to the user and on the basis of the data acquired by the motion data acquirer 245. Specifically, the limiting condition generator 246 carries out processing of generating limiting conditions such as a range (movement range) in which each part of the user can actually move, a maximum possible velocity or torque, and idiosyncrasy of a trajectory due to a habit or the like, according to the type of sport and the type of practice selected by the user and on the basis of the data acquired by the motion data acquirer 245. These various limiting conditions are accumulated in association with identification information of the user, as personal motion data 262 in the memory 26.

The motion analyzer 247 carries out processing of making a calculation using a motion model, described later, and analyzing a preferable movement of a human body model within a range such that the parameters of the human body model satisfy the limiting conditions generated by the limiting condition generator 246.

For example, the motion analyzer 247 may calculate a theoretical maximum velocity of a node provided at a site on the human body model, within a range that satisfies the limiting conditions. Specifically, the motion analyzer 247 carries out processing of calculating a velocity (maximum end-point velocity) at which a node provided at a distal end of the human body model moves most efficiently, on the basis of the limiting conditions generated by the limiting condition generator 246 and according to the type of sport and the type of practice selected by the user, and calculating a movement condition such as a parameter value for achieving the maximum end-point velocity. The “velocity” in this case refers to a broad concept, and a velocity such as extension velocity, tangential velocity, acceleration or angular velocity is selected according to the type of sport and the type of practice that are selected.

In the embodiment, the motion analyzer 247 reads out information of a motion model and a calculation formula for its end-point velocity corresponding to the type of sport and the type of practice selected by the user, from basic data 264 stored in the memory 26, and calculates a maximum end-point velocity, applying the limiting conditions to this calculation formula.

After the limiting conditions are accumulated as the personal motion data 262, the motion analyzer 247 in the embodiment analyzes a preferable movement, using the limiting conditions accumulated as the personal motion data 262.

The standard training decider 248 carries out processing of generating a standard training menu as a kind of exercise instruction information, on the basis of the result of the analysis by the motion analyzer 247. Specifically, the standard training decider 248 carries out processing of acquiring information such as the physique of the user from the personal information acquirer 241 and generating a standard training menu for instruction indicating a preferable movement (ideal form) corresponding to the physique and movement habits of the user based on the result of the analysis by the motion analyzer 247, using original data included in the basic data 262. The standard training decider 248 sends information about the generated standard training menu to the advice information generator 244.

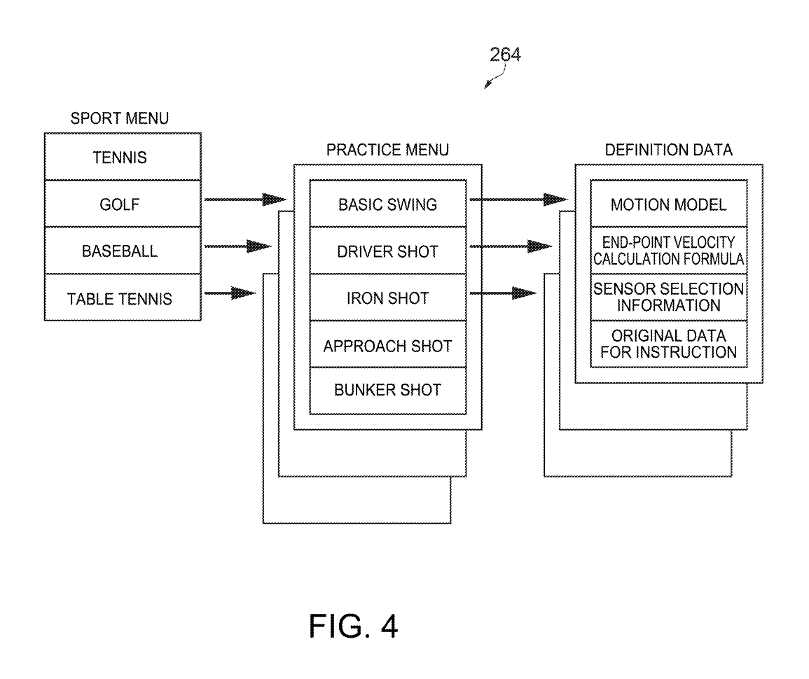

FIG. 4 shows an example of the configuration of the basic data 264. In the embodiment, the basic data 264 includes information of a sport menu, information of a practice menu, and definition data necessary for generating a standard training menu. A separate practice menu is associated with each type of sport in the sport menu, and separate definition data is associated with each item in the practice menu. For example, if the user selects golf from the sport menu, practice menu items such as drive shot, approach shot, and bunker shot are selectable, corresponding to the selected sport of golf (type of sport). With each of these practice menu items, definition data is associated. The definition data includes a motion model, a calculation formula for end-point velocity, sensor selection information, original data for instruction, and the like.

The motion model defines a human body model showing at least a part of a human body in a simplified form with a line connecting nodes, a coordinate system and parameters of this human body model, an allowable range of each parameter value (realistically possible range), an upper limit value of end-point velocity (realistically possible upper limit value), and the like.

The calculation formula for end-point velocity is a formula for calculating the velocity of a node (end node) at a distal end that is the most distant from the origin in the human body model (center of rotation), using parameters of the human body models as variables.

The sensor selection information is selection information about the type of the sensor module 10 (type of the sensor included in the sensor module 10) necessary for acquiring data about a movement of the user, and its mounting position, or the like.

The original data for instruction is original data for the standard training decider 248 to generate an image of a movement or an instruction voice, in order to prompt the user to make this movement and thus acquire limiting conditions. The original data may be image frame data or maybe time-series data of parameter values of the human body model.

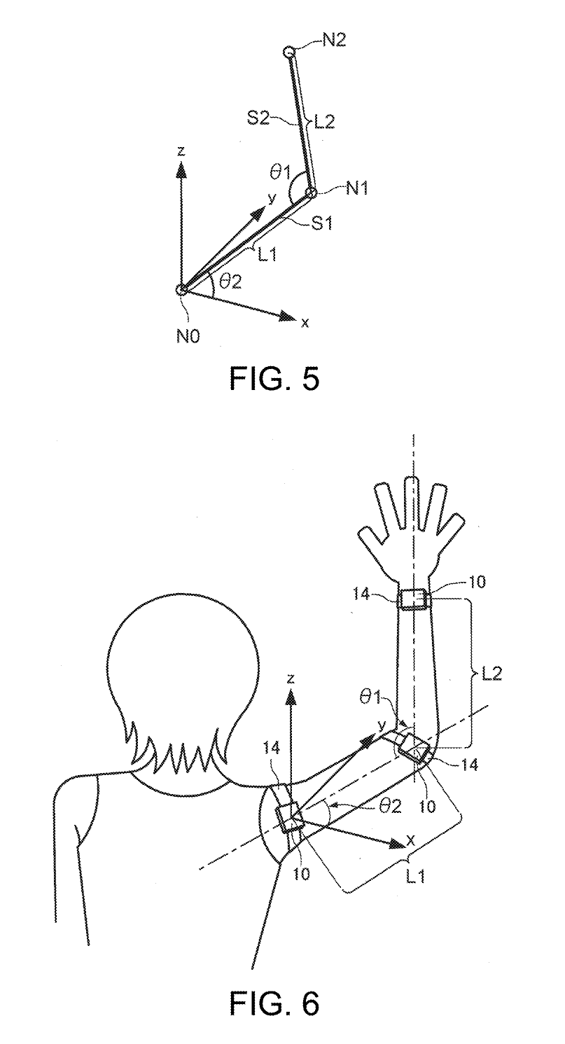

FIG. 5 explains an arm motion model. As shown in FIG. 5, the arm motion model defines, for example, a human body model made up of a node NO corresponding to the shoulder, a node N1 corresponding to the elbow, a node N2 corresponding to the wrist, a straight line S1 connecting the node N0 to the node N1, and a straight line S2 connecting the node N1 to the node N2, a coordinate system (xyz coordinate system in which the node NO is the origin) and parameters (θ1, θ2, L1, L2) of this human body model, an allowable range of each parameter value, an upper limit value of the velocity V (equivalent to an end-point velocity) of the node N2, a calculation formula for the velocity (end-point velocity) V of the node N2, and the like. Here, θ1 is the angle formed by the straight line S1 and the straight line S2, and θ2 is the angle formed by a specific axis (for example, the x-axis) and the straight line S1. L1 is the length of the straight line S1. L2 is the length of the straight line S2.

When providing an ideal form of the arm, such an arm motion model is used. Meanwhile, in order to acquire the actual movement of the arm, the sensor modules 10 are mounted with the band 14 as shown in FIG. 3, for example, on the shoulder, elbow and wrist of the user's arm, as shown in FIG. 6.

The coordinate system of the sensor module 10 mounted on the shoulder (the coordinate system of the three-axis acceleration sensor 102 or the three-axis gyro sensor 104) is coordinated with the coordinate system of the motion model. At this time, the angle formed by the center axis of the upper arm and the center axis of the lower arm is equivalent to θ1, and the angle formed by a specific axis (for example, the x-axis) of the sensor module mounted on the shoulder and the center axis of the upper arm is equivalent to θ2. The length of the upper arm (distance between the shoulder and the elbow) is equivalent to L1. The length of the lower arm (distance between the elbow and the wrist) is equivalent to L2.

The angles θ1 and θ2 can be calculated from the result of integration by the gyro sensor 104 or the like. The positions of the nodes N1 and N2 (their relative positions to the node N0) can be calculated from the result of integration by the acceleration sensor 102 or the magnetic direction sensor, or the like. The velocity of the node N2 (equivalent to the end-point velocity V) can be calculated from the result of integration by the acceleration sensor 102 mounted on the wrist.

### (2) Acquisition of Profile of Similar Person

Back to FIG. 1, the function relating to the acquisition of the profile of a similar person is implemented by the personal information acquirer 241, the physical fitness information acquirer 242 and the similar profile searcher 243. The similar profile searcher 243 is equivalent to the searcher and the history information acquirer.

The physical fitness information acquirer 242 acquires physical fitness information of the user on the basis of the biological information such as pulse rate, body temperature and blood pressure detected by the sensor module 15, the information about rotation, shift and acceleration of body parts detected by the sensor modules 10, and the physical information, the attribute information and the like acquired from the personal information acquirer 241.

In the embodiment, the physical fitness information is information indicating basal metabolism, explosive power and endurance or the like. To obtain such information, a physical fitness test may be conducted on the user in advance, and pulse rates that change with the amount of exercise and the exercise load obtained in the test may be detected so as to estimate the user's physical fitness. For example, after a known physical fitness test such as a ramp test or step test is carried out as a predetermined physical fitness test, if the peak in the pulse rate is high, it is determined that the user has explosive power, whereas if the flat part in the pulse rate is long, it is determined that the user has endurance. The information about physical fitness acquired by the physical fitness information acquirer 242 is sent to the similar profile searcher 243.

The similar profile searcher 243 searches for profile information similar to that of the user, from data saved in a motion data management server 50, which is a database, on the basis of the information acquired by the personal information acquirer 241 and the physical fitness information acquirer 242.

In the embodiment, the controller 20 is set to be able to communicate, via the communicator 22, with the motion data management server 50 connected to the network 40. In the motion data management server 50, data about exercise records such as training history or the like of the user using the exercise instruction system 5 are accumulated at any time. These data are set to be able to be referred to and shared by the controller 20.

The training history includes the training menu executed by the user, the training duration, the amount of movement, trajectories and the like. Also, the processor (CPU) 24 also has the function of causing the motion analyzer 247 to analyze the motion of the user and sending the result of the analysis to the motion data management server 50.

The similar profile searcher 243 first searches for another user (similar person) whose profile data including physique information, attribute information and physical fitness information is similar to that of the user wearing the controller 20, from each data stored in the motion data management server 50. The degree of similarity may be determined on the basis of the relative distance between parameters of each data, for example, on the basis of the Euclidean distance. In the embodiment, the similar profile searcher 243 searches for profile data in which the Euclidean distance is at a minimum value, and determines a user having the profile data with the minimum value as an similar person who is similar to the user wearing the controller 20.

The similar profile searcher 243 then acquires information about the history of training carried out by the similar person from the motion data management server 50, and sends the acquired information about the history of training to the advice information generator 244.

### (3) Decision on Recommended Training Menu

The function relating to the decision on a recommended training menu is implemented by the advice information generator 244. The advice information generator 244 is equivalent to the generator.

The advice information generator 244 modifies the standard training menu sent from the standard training decider 248, on the basis of the history information sent from the similar profile searcher 243, and generates advice information indicating a training menu suitable for the user wearing the controller 20. The advice information generator 244 also outputs the generated advice information to the HMD 60 and the speaker 70 from the output 28 and thus notifies the user. The generated advice information may be recorded as data in the recording medium 80.

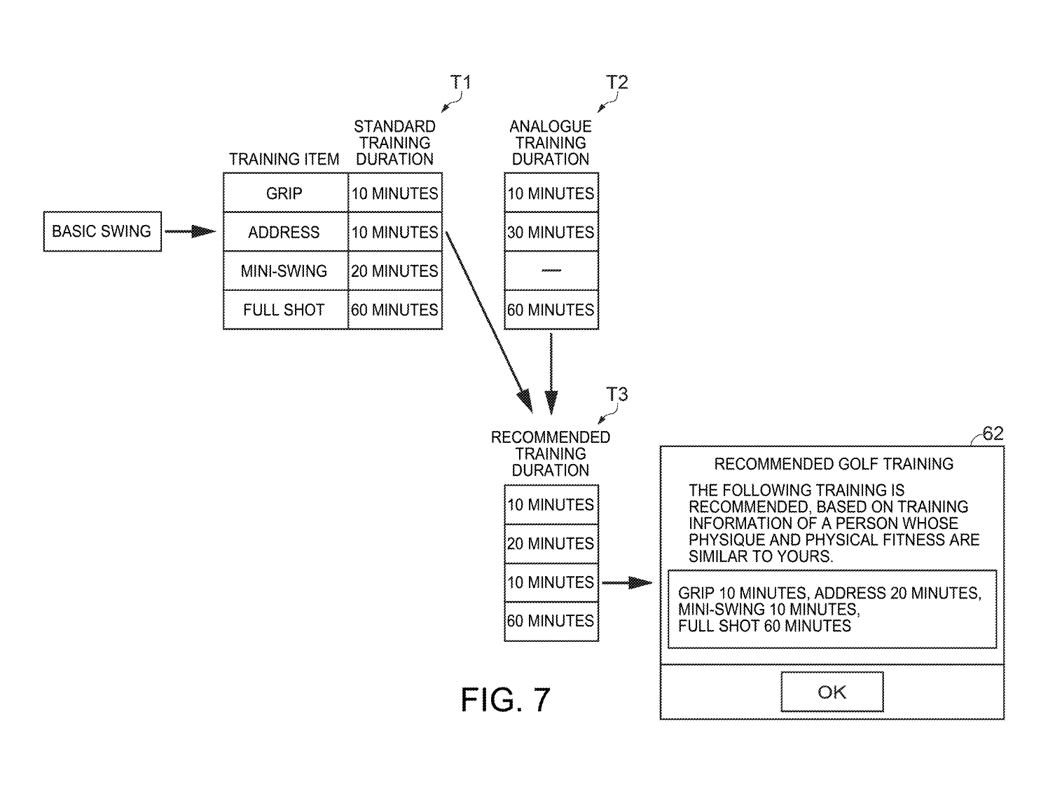

Now, an example of the generation of advice by the advice information generator 244 will be described with reference to FIG. 7. In FIG. 7, it is assumed that the user selects golf from the sport menu and then selects basic swing from the practice menu.

The advice information generator 244 receives information of the training items of grip, address, mini-swing and full shot, and a standard training duration (first training duration) T1 set for each item, as a standard training menu, from the standard training decider 248.

Also, the advice information generator 244 receives information of an similar person training duration T2 indicating the training history of the similar person from the similar profile searcher 243.

Then, the advice information generator 244 decides a recommended training duration (third training duration) T3 to be recommended to the user, on the basis of the standard training duration T1 and the similar person training duration (second training duration) T2, and creates advice for the user.

In this case, the advice information generator 244 employs the method of calculating the average of the standard training duration T1 and the similar person training duration T2 and defining the result of the calculation as the recommended training duration T3. However, this method is not limiting. Since recommended training is thus decided with reference to the training actually carried out by the similar person, instead of recommending standard training as it is, the user is more likely to respond favorably or agree to the recommended training.

As the wording of the advice to be created, one of prepared texts may be selected according to the profile of the user, that is, the physique information and the attribute information.

Also, the user may be prompted to input information about his/her own personality in advance, and advice and training items may be decided according to the personality inputted by the user. For example, if the user inputs a personality such that he/she does things at his/her own pace, mild advice such as advice for gentle training may be created. Meanwhile, if the user inputs that he/she is a persistent personality, training items and the recommended training duration T3 to achieve high performance may be created.

The advice information generator 244 outputs the recommended training duration T3 and the advice that are created, to the output 28.

FIG. 7 shows an example of a user interface screen 62 showing the recommended training duration T3 and the advice displayed on the HMD 60.

The advice information generator 244 is not limited to displaying the advice on the screen and may also generate audio data including advice contents and output the audio data from the speaker 70.

Such an image or audio may be outputted on the display or the speaker 70 of a wristwatch-type device or mobile phone. Also, the image or audio may be transmitted to an external information device via the network 40 and outputted to a device other than the device mounted on the body, such as the monitor or speaker of the information device.

Moreover, it is also conceivable that a vibration signal is generated according to the advice so as to vibrate the vibration element of the information device, thus notifying the user.

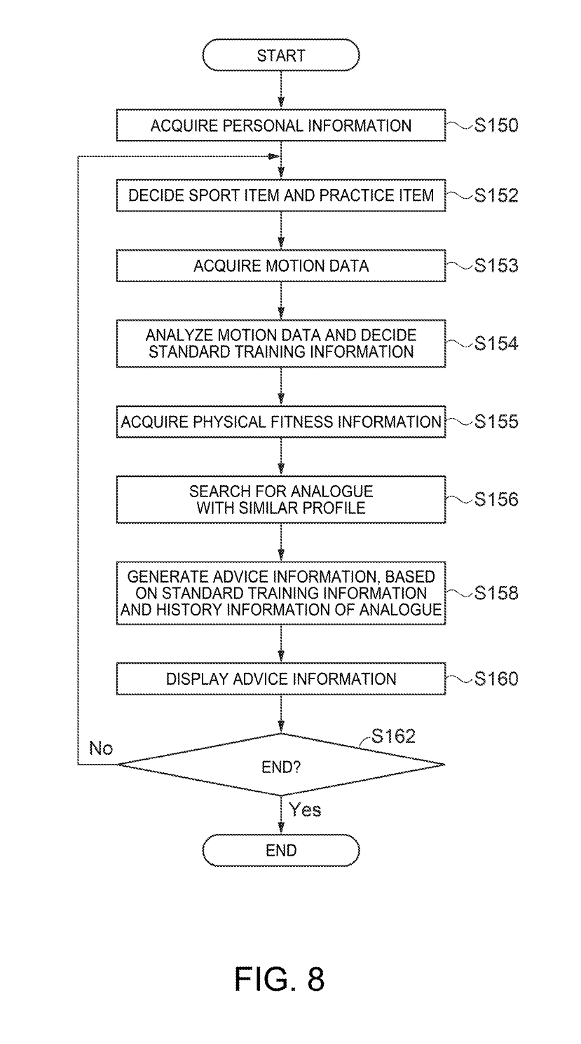

FIG. 8 is a flowchart showing a flow of processing in an advice generation method. This processing is implemented by the processor 24 executing an advice generation program.

As this processing starts, the processor 24 acquires personal information of a user to whom exercise instructions are to be given (step S150) (acquisition of personal information).

Next, the processor 24 displays a sport menu and a practice menu to prompt the user to select a sport item and a practice item, and decides the sport item and the practice item on which advice is to be given (step S152).

Then, the processor 24 acquires motion data (step S153) and analyzes the acquired motion data to decide standard training information (step S154).

Next, the processor 24 acquires physical fitness information of the user (step S155).

Subsequently, the processor 24 searches for an similar person who has a similar profile that is the most similar to that of the user (step S156) (search).

Next, the processor 24 acquires history information of the similar person (acquisition of history information) and generates advice information on the basis of the acquired history information and the standard training information (step S158) (generation).

Then, the processor 24 displays the generated advice information and notifies the user (step S160) (output).

Subsequently, the processor 24 determines whether to end the processing or not (step S162). If the processor 24 determines that the processing is not to end (No in step S162), the processor 24 returns to step S152.

Meanwhile, if the processor 24 determines that the processing is to end (Yes in step S162), the processor 24 ends the sequence of processing.

As described above, according to the exercise instruction system 5, a preferable movement (ideal movement) is analyzed by making a calculation based on a motion theory using a motion model prepared in advance. Moreover, exercise history of an similar person who has a profile that is the most similar to that of the user is acquired, and advice on an exercise for the user is generated with reference to the exercise history of the similar person. Therefore, suitable advice which is not unreasonable to the user and to which the user is more likely to respond favorably or agree can be generated.

While the embodiment of the invention is described with reference to the drawings, the specific configurations are not limited to this embodiment and include design changes and the like without departing from the scope of the invention. For example, the training duration of an similar person with a similar profile may be used as a recommended training duration.

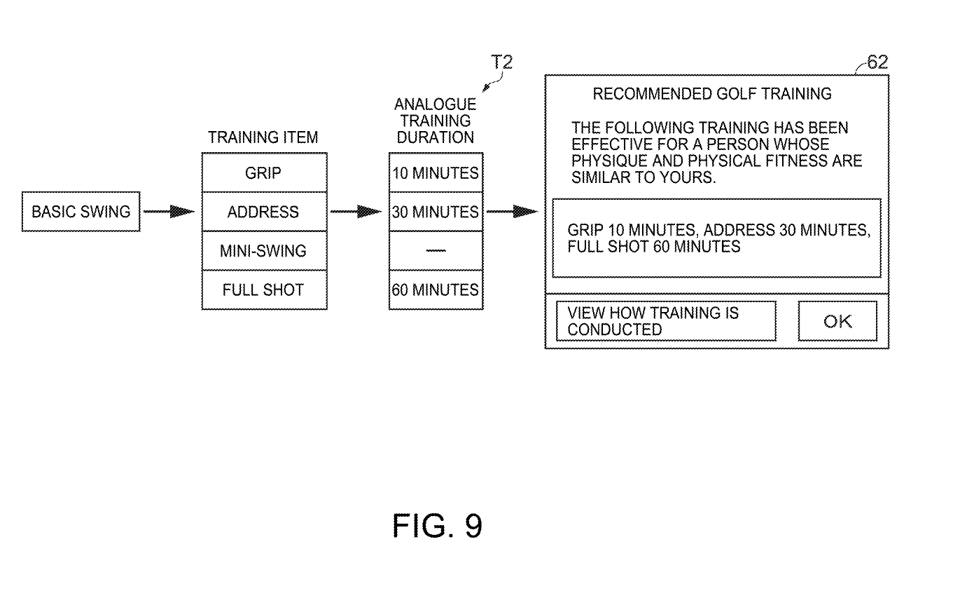

FIG. 9 shows a modification example. The advice information generator 244 creates advice for the user, using the information of the similar person training duration T2 received from the similar profile searcher 243 as the recommended training duration T3, and outputs the advice in the form of a user interface screen 62. In this case, on the user interface screen 62, it is emphasized that training based on the similar person training duration T2 has been effective for the similar person.

Also, a button for viewing how the training is conducted is arranged in a selectable manner on the user interface screen 62. By selecting this button, the user can view the video showing how another user carries out training, his/her motion trajectory, and the like. Such visual disclosure of training enables the user to execute the same training more easily.

As a way of disclosing information to increase the user's motivation, for example, it is possible to disclose effects achieved by another user executing the similar person training duration T2 (for example, improvement in golf scores). This can offer the user a positive motivation for recommended training.

The controller 20 may be implemented by a single device or may be implemented by a combination of a plurality of devices, and therefore includes various configurations.

Each functional component of the processor 24 shown in FIG. 1 is described as having a functional configuration implemented by the collaboration of hardware such as a CPU and memory, and software, and is not limited to any particular specific form of installation. Therefore, hardware corresponding to each individual functional component need not necessarily be installed, and functions of a plurality of functional components can be implemented by a single processor executing a program. Also, apart of the functions implemented by software in the embodiment may be implemented by hardware, or a part of the functions implemented by hardware may be implemented by software. Moreover, the specific details of the configurations of other components of the exercise instruction system 5 can be arbitrarily changed without departing from the scope of the invention.

What is claimed is:

1. An advice generation method comprising:
acquiring personal information about a user;
searching for an similar person who is similar to the user on the basis of the personal information;
acquiring history information about physical training carried out by the similar person; and
generating advice information on the physical training for the user on the basis of the history information.

2. The advice generation method according to claim 1, wherein
in the acquisition of the personal information, the personal information including biological information about a biological body and motion information about a movement is acquired.

3. The advice generation method according to claim 1, wherein
in the search, on the basis of profile information including physical fitness information about physical fitness of the user and the personal information, the similar person who has the profile information that is the most similar to that of the user is searched for from information saved in a database.

4. The advice generation method according to claim 1, wherein
in the acquisition of the history information, the history information including a training item carried out in the physical training and a training duration of the training items is acquired.

5. The advice generation method according to claim 4, wherein
in the generation, a first training duration for the training item is decided on the basis of the motion information, and a third training duration recommended in the advice information is decided on the basis of the first training duration that is decided and a second training duration indicated by the history information.

6. The advice generation method according to claim 1, wherein
in the generation, the history information of the similar person is generated as the advice information.

7. The advice generation method according to claim 2, wherein
the biological information includes at least one of pulse rate, body temperature and blood pressure in the biological body.

8. The advice generation method according to claim 2, wherein
the motion information includes at least one of acceleration and angular velocity generated by a movement of the user.

9. The advice generation method according to claim 1, further comprising
outputting the advice information that is generated.

10. An advice generation program causing a computer to execute:
a personal information acquisition function of acquiring personal information about a user;
a search function of searching for an similar person who is similar to the user on the basis of the personal information;
a history information acquisition function of acquiring history information about physical training carried out by the similar person; and
a generation function of generating advice information on the physical training for the user on the basis of the history information.

11. An advice generation system comprising:
a personal information acquirer which acquires personal information about a user;
a searcher which searches for an similar person who is similar to the user on the basis of the personal information;
a history information acquirer which acquires history information about physical training carried out by the similar person; and
a generator which generates advice information on the physical training for the user on the basis of the history information.

12. An advice generation device comprising:
a personal information acquirer which acquires personal information about a user;
a searcher which searches for an similar person who is similar to the user on the basis of the personal information;
a history information acquirer which acquires history information about physical training carried out by the similar person; and
a generator which generates advice information on the physical training for the user on the basis of the history information.

13. The advice generation device according to claim 12, wherein
the personal information acquirer acquires the personal information including biological information about a biological body and motion information about a movement.

14. The advice generation device according to claim 12, wherein
on the basis of profile information including physical fitness information about physical fitness of the user and the personal information, the searcher searches for the similar person who has the profile information that is the most similar to that of the user from information saved in a database.

15. The advice generation device according to claim 12, wherein
the history information acquirer acquires the history information including a training item carried out in the physical training and a training duration of the training items.

16. The advice generation device according to claim 15, wherein
the generator decides a first training duration for the training item on the basis of the motion information and decides a third training duration recommended in the advice information on the basis of the first training duration that is decided and a second training duration indicated by the history information.

17. The advice generation device according to claim 12, wherein
the generator generates the history information of the similar person as the advice information.

18. The advice generation device according to claim 12, further comprising
an output which outputs the advice information generated by the generator.

19. An advice generation device comprising a processor which executes processing of:
acquiring personal information about a user;
searching for an similar person who is similar to the user on the basis of the personal information;
acquiring history information about physical training carried out by the similar person; and
generating advice information on the physical training for the user on the basis of the history information.

20. An advice generation system which:
acquires personal information about a user;
searches for an similar person who is similar to the user on the basis of the personal information;
acquires history information about physical training carried out by the similar person; and
generates advice information on the physical training for the user on the basis of the history information.
